(19) United States
(12) Patent Application Publication
(10) Pub. No.: US 2011/0167336 A1
(43) Pub. Date: Jul. 7, 2011

(54) GESTURE-BASED WEB SITE DESIGN

(75) Inventors: David Elmo Aitken, Eagle Mountain, UT (US); Charles Henry Jackson, Orem, UT (US); Ronald Jeremy Aitken, Draper, UT (US); Joshua B. Hoecherl, Salt Lake City, UT (US)

(73) Assignee: HIT DEVELOPMENT LLC, Provo, UT (US)

(21) Appl. No.: 12/651,941

(22) Filed: Jan. 4, 2010

(51) Int. Cl. G06F 3/048; G06F 17/00; G06F 3/033

(52) U.S. Cl. 715/239; 715/769; 715/863; 715/810

(57) ABSTRACT

A method of generating a web site including one or more web pages includes receiving user input including a selection of one of a plurality of web site layouts, each web site layout including a plurality of elements configured to be customized by a user. The plurality of elements of the selected web site layout is displayed on a display device, including a first element displayed in a first position on the display device. User input including a drag and drop action performed on the first element is received. The first element is then displayed in a second position on the display device, the second position being different than the first position according to the user input including the drag and drop action.

### BACKGROUND

1. The Field of the Invention

Some example embodiments of the invention generally relate to web site hosting and design.

2. The Relevant Technology

Traditional business models using brick and mortar stores to sell products and services have been enhanced and even replaced over the last several years by online store fronts that provide end users throughout the world the ability to view and purchase a business's products and services over the Internet. Unfortunately, many small- and mid-sized businesses are limited in their access to the software and server system solutions required to implement an online store front. For instance, most of the hardware and software required to support an online store front remains prohibitively expensive. The IT personnel and/or training required to maintain and administer an online store front may represent a considerable additional expense that businesses are unable to support. As a result, many small- and mid-sized businesses lacking online store fronts are losing market share to larger businesses and national chains that can spread these expenses across a broader customer base.

Rather than investing in their own hardware, software, IT personnel and/or training, many businesses are turning to web site hosting services that have the hardware, software, personnel and technical expertise necessary to support a web site. Some such web site hosting services additionally provide web site design services that provide the businesses with the opportunity to create a customized hosted web site.

Creating a truly customized web site is conventionally a long and drawn out process that requires a significant amount of technical expertise. For instance, many web site editors present web pages to a designer in hypertext markup language (“HTML”). A designer has to have the technical expertise to write the HTML code in the first place and/or to make aesthetic changes to the corresponding web site that are not immediately apparent to a layman until the HTML code for the web site is executed in a browser or other application.

Further, many conventional web site editors require the use of various intermediate applications, such as Photoshop, to change elements such as images that are to be included in a web site. For instance, conventional web site editors do not permit a designer to modify an image. Instead, the designer has to modify the image in Photoshop (or other suitable application), publish the image out, save it to a known location, and then reference the known location in the HTML code.

Due to the time, effort and cost involved in creating a web site, web sites are generally designed for the broadest appeal possible. For examples, web sites for national chains are typically designed to appeal to end users in New York as well as end users in Idaho. In many cases, however, end users in New York are not going to be motivated by the same factors as end users in Idaho.

The subject matter claimed herein is not limited to embodiments that solve any disadvantages or that operate only in environments such as those described above. Rather, this background is only provided to illustrate one exemplary technology area where some embodiments described herein may be practiced

### BRIEF SUMMARY OF SOME EXAMPLE EMBODIMENTS

In general, example embodiments relate to a methods and systems of servicing requests from client devices for access to web sites and methods and systems of generating web sites.

In one example embodiment, a method of generating a web site including one or more web pages includes receiving user input including a selection of one of a plurality of web site layouts, each web site layout including a plurality of elements configured to be customized by a user. The plurality of elements of the selected web site layout is displayed on a display device, including a first element displayed in a first position on the display device. User input including a drag and drop action performed on the first element is received. The first element is then displayed in a second position on the display device, the second position being different than the first position according to the user input including the drag and drop action.

In another example embodiment, a method of generating a web site including one or more web pages includes receiving user input corresponding to a gesture performed by a user via an input device. The user input is analyzed to identify the gesture. An action associated with the identified gesture is implemented, the action including creating a layout for a web site having a plurality of web pages, the layout including a plurality of elements. At least one of the elements is uniformly included across each of the plurality of web pages. The elements of the layout are displayed on a display device. User input customizing one or more of the elements is received. The layout is published as a web site.

These and other aspects of example embodiments will become more fully apparent from the following description and appended claims.

### BRIEF DESCRIPTION OF THE DRAWINGS

To further clarify various aspects of some embodiments of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates one embodiment of an example operating environment in which embodiments of a host server and client devices can be implemented;

FIG. 2 depicts an example embodiment of a conversion application that can be hosted on the host server of FIG. 1;

FIG. 3 depicts an example embodiment of a design component included as part of the conversion application of FIG. 1 that can be executed on one of the client devices of FIG. 1;

FIG. 4 illustrates an example layout for a web site that can be selected and customized using the design component of FIG. 3;

FIGS. 5A-5B depict color schemes that can be adjusted using the design component of FIG. 3;

FIG. 6 illustrates an example layout for a web site that can be created in response to gesture-based user input using the design component of FIG. 3;

FIG. 7 depicts various shapes corresponding to gestures that can be performed by a user to implement certain actions using the design component of FIG. 3;

FIG. 8 is a flow chart of an example method of servicing requests from client devices for web pages;

FIG. 9 is a flow chart of an example method of generating a web site including one or more web pages; and

FIG. 10 is a flow chart of another example method of generating a web site including one or more web pages.

### DETAILED DESCRIPTION OF EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

### I. Example Operating Environment

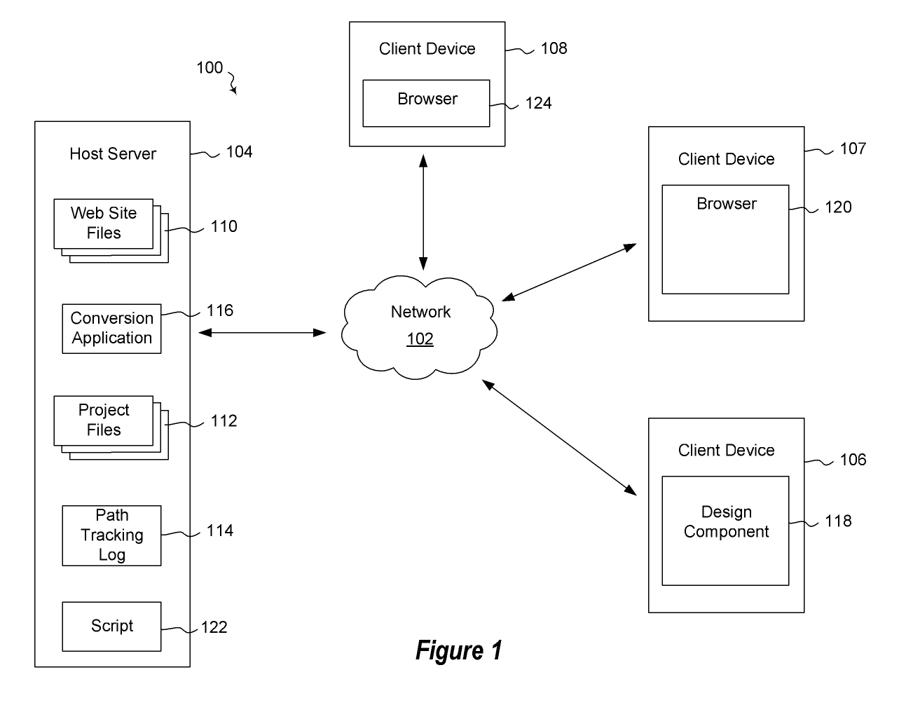

With reference now to FIG. 1, a first example operating environment 100 is illustrated in which some embodiments can be practiced. The example operating environment 100 includes a network 102 over which various network devices communicate with each other and perform various other functions described herein. The network devices access and read associated computer-readable media having stored thereon data and/or computer-executable instructions for implementing various methods. Generally, a network device includes a communication device for transmitting and receiving data and/or computer-executable instructions over the network 102, and a memory for storing data and/or computer-executable instructions. A network device may also include a processor for processing data and executing computer-executable instructions, as well as other internal and peripheral components that are well known in the art (e.g., input and output devices). As used herein, the term “computer-readable medium” includes tangible computer-readable media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. The term “computer-readable medium” also includes intangible computer-readable media such as propagated signals representing data and computer-executable instructions.

The network 102 is illustrated in simplified form and exemplarily includes the Internet, including a global internetwork formed by logical and physical connections between multiple wide area networks and/or local area networks. Alternately or additionally, the network 102 includes a cellular RF network and/or one or more wired and/or wireless networks such as, but not limited to, 802.xx networks, Bluetooth access points, wireless access points, IP-based networks, or the like. The network 102 also includes servers that enable one type of network to interface with another type of network.

A network device generally includes any device that is capable of communicating with the resources of the network 102. For instance, the network devices of example operating environment 100 include a host server 104 and a plurality of client devices 106, 107, 108 (collectively “client devices 106-108”). The host server 104 hosts a plurality of web sites created by administrators for various customers, which web sites can be accessed by end users. In the present example, the client device 106 is associated with an administrator that operates client device 106 to create new web sites and edit existing web sites and may be specifically referred to herein as “administrator client device 106.” The client device 107 is associated with an end user who operates client device 107 to access the hosted web sites from host server 104 and may be specifically referred to herein as “end user client device 107.” The client device 106 is associated with a customer of the web hosting services provided by host server 104 and may be specifically referred to herein as “customer client device 106.”

Each of client devices 106-108 is a desktop computer, laptop computer, wireless or mobile telephone, smart phone, personal digital assistant (“PDA”), or any other network device able to communicate over the network 102 and perform the other functions described herein.

In the illustrated embodiment of FIG. 1, the host server 104 stores a plurality of web site (or web page) files 110 that are hosted for various customers, a plurality of project files 112 and a path tracking log 114. Each web site file 110 corresponds to a project file 112 that includes an object representation of elements included in the corresponding web site file 110. The path tracking log 114 stores information regarding the paths that end user client devices 107 navigate through the web pages of web site files 110. These paths are referred to herein as navigation paths.

One aspect of some embodiments described herein is the ability to provide market-specific content to end users requesting web site files 110 based on the market(s) to which the end users belong. Each market corresponds to a particular geographic area or grouping of end users. The market-specific content in some embodiments is included in landing pages or overlay messages associated with the web site files 110. In some examples, the host server 104 stores one or more data structures, e.g., in web site files 110, each including a different market-specific landing page or market-specific overlay message.

The host server 104 further includes a conversion application 116 configured to, among other things, read the IP address of end user client device 107 when a particular web site file 110 is requested, associate a particular geographic location with the client device 107 based on the IP address, and return a market-specific data structure including a market-specific landing page or market-specific overlay message to the client device 107. In some examples, the conversion application 116 includes one or more of a design component, an overlay component and a counter component.

The administrator client device 106 includes design component 118, which is part of the conversion application 116 in some examples. The design component 118 is a web site and graphic editor for creating and editing web sites. Some embodiments of the design component 118 permit an administrator or other user to drag and drop elements of a web site and/or provide gesture-based inputs to create and/or edit elements within a web site. Alternately or additionally, the design component 118 includes a live preview capability that permits the customer associated with customer client device 108 to view screen shots of administrator client device 106 substantially in real time as the administrator creates and/or edits the customer's web site. As such, some embodiments described herein simplify and accelerate the process of creating and designing web sites.

End user client device 107 executes a browser 120 or another suitable application for interacting with web site files 110 hosted by host server 104. In some embodiments, the browser 120 issues hypertext transfer protocol (“HTTP”) service requests to communicate with host server 104 and retrieve a particular web site file 110. Typically, the requested web site file 110 is loaded on the end user client device 107 a web page at a time.

In some examples, the host server 104 includes a logging script 122. In this and other examples, the end user client device 107 requests the web page from the host server 104. The host server 104 re-writes the request to the logging script 122. The logging script 122 logs the request in the path tracking log 114, including one or more of the IP address of the end user client device 107, a URI of the requested web page, a time stamp, a search header including a URI or other identifier for an external reference (e.g., a search engine results page) that directed the end user client device 107 to the requested web page, one or more keywords included in the search header, the country/state/region/city in which the end user client device 107 is located, or the like or any combination thereof. The logging script 122 then outputs a response to the end user client device's 107 original request, which response is downloaded to the end user client device 107.

Customer client device 108 also executes a browser 124 or other suitable application to view screen shots from administrator client device 106 substantially in real time as the administrator makes changes to the customer's web site.

### II. Conversion Application

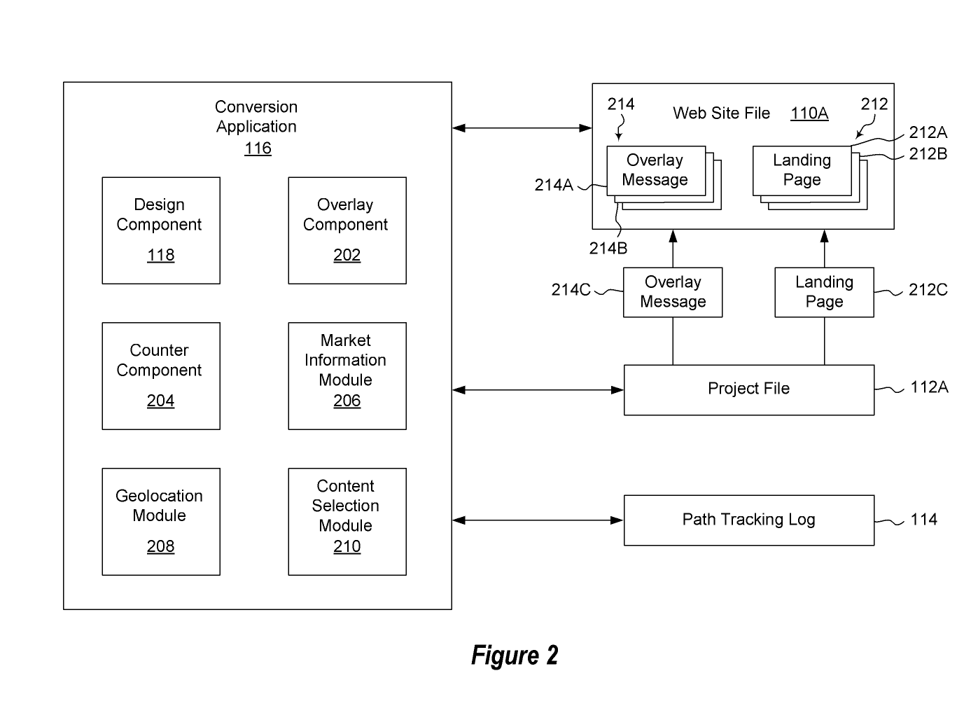

With additional reference to FIG. 2, an example configuration of the conversion application 116 is disclosed. As illustrated in FIG. 2, the conversion application 116 includes design component 118, overlay component 202 and counter component 204. Additionally, the conversion application 116 includes a market information module 206, a geolocation module 208 and a content selection module 210. Each of the design component 118, overlay component 202 and counter component 204 is an application that can be run separately from the conversion application 116.

As previously explained above, the design component 118 is a web site and graphic editor for creating and editing web sites. As will be explained in greater detail below, the design component 118 permits an administrator or other user to create and/or edit a plurality of landing pages 212 for each web site file 110. In the example of FIG. 2, a particular web site file 110A is illustrated. The landing pages 212 are data structures such as hypertext markup language (“HTML”) pages or other suitable data structures stored in the corresponding web site file 110A.

Generally, the landing pages 212 include market-specific content. As used herein, the term “market-specific content” refers to content customized for a particular market defined in terms of a geographic area. Accordingly, the landing pages 212 may include a first landing page 212A including content directed to a first market defined by a first geographic area, a second landing page 212B including content directed to a second market defined by a second geographic area, and so on. As such, the landings pages 212 are market-specific landing pages 212. It will be appreciated that the use of market-specific landing pages 212 permits a web site administrator to customize promotions, offers, and/or other content provided through a web site 110A to one or more geographically-defined markets.

The overlay component 202 is configured for creating and editing overlay messages 214 that are displayed to an end user when a web site file 110 is first accessed by an end user client device 107. The overlay messages 214 are data structures that are also stored in a corresponding web site file 110A. In some embodiments, overlay messages 214 are at least partially transparent messages that are overlayed on a default landing page of a web site file 110. The overlay messages 214 may be configured to disappear after a predetermined period of time and/or to gradually fade, e.g., grow increasingly transparent, until disappearing after a predetermined period of time.

Optionally, the overlay messages 214 include market-specific content. Although the web site file 110A is depicted in FIG. 2 as including both market-specific landing pages 212 and market-specific overlay messages 214, in other embodiments the web site file 110A includes only market-specific landing pages 212 or market-specific overlay messages 214, but not both.

The counter component 204 is configured for tracking the behavior of end users accessing web site files 110 and for generating statistics relating to conversions. As used herein, the term “conversion” refers to any desired action performed by an end user accessing a web site file 110. For a content driven web site, the term “conversion” may thus include an end user accessing particular content (such as an advertisement) displayed in the browser 120 within a web page of web site file 110. For an e-commerce web site, the term “conversion” may include an end user completing an electronic financial transaction through web site 110 to purchase a product or service, for example. For a lead-generating web site, the term “conversion” may include an end user submitting certain user information, such as name, phone number, email address, or other user information through the web site 110 to inquire about a particular product, service, or the like offered through the web site 110. The specific examples of “conversion” described herein are provided by way of example only and should not be construed to limit the invention.

As explained previously, path tracking information can be stored in path tracking log 114. In some embodiments, the counter component 204 generates statistics using the path tracking information from path tracking log 114. The statistics generated by the counter component 204 may include conversion rate as a function of market, landing page 212, overlay message 214, navigation path through web site 110A, or the like or any combination thereof.

The market information module 206 is configured to collect information about particular markets as an aid in generating market specific landing pages 212 and/or overlay messages 214. In some embodiments, for instance, in the process of creating a new landing page 212C or new overlay message 214C for a new market, the market information module 206 searches the network 102 for or otherwise collects information relating to the geographic area corresponding to the new market. For example, if the new market is defined as the Washington, D.C. area, the market information module 206 collects information about the Washington, D.C. area by, e.g., running online search using Washington, D.C. as a keyword for the search. In a similar manner, the market information module 206 can collect information about any new market defined in terms of any geographic area, including a particular town, city, metropolitan area, state, nation, continent, or the like.

In these and other examples, an administrator using, e.g., administrator client device 106, executes design component 118 on administrator client device 106 to access project file 112A corresponding to web site file 110A. In some embodiments, the administrator client device 106 communicates with counter component 204 to identify a subset of the landing pages 212 that are most successful. Success may be determined based on conversion rate, for instance, such that the counter component 204 may identify the top five (or some other number) landing pages 212 according to conversion rate. Upon identifying the subset of landing pages 212, the design component 118 executing on administrator client device 106 displays representations stored within project file 112A of the subset of landing pages 212 on the administrator client device 106. The administrator can then select a representation of one of the subset of landing pages 212 as a starting point for new landing page 212C, customizing the selected representation to include market-specific content corresponding to a new market. Optionally, the administrator may include information collected by market information module 206 in the customized representation.

After completing the customized representation, the design component 118 executing on client device 106 publishes the customized representation to a new landing page 212C in a suitable format. For example, the new landing page 212C may be published as an HTML page. The new landing page 212C is then added to the web site file 110A where it is provided to an end user client device 107 if the conversion application 116 determines that the end user client device 107 is located in the geographic area corresponding to the new market associated with the new landing page 212C.

Alternately or additionally, an administrator using an administrator client device 106 executing the overlay component 202 can access project file 112A corresponding to web site file 110A to create the new overlay message 214C and add the new overlay message 214C to the web site file 110A, analogous to the creation and addition of new landing page 212C to web site file 110A.

The geolocation module 208 is configured to read the IP address from each request to access web site file 110A issued by end user client device 107 and then associate a geographic location with the end user client device 107 based on the IP address.

Alternately or additionally, the geolocation module 208 identifies whether the end user client device 107 issuing the request to access web site file 110A is a mobile end user client device. This determination may be based on the IP address read from the request.

The content selection module 210 determines whether the associated geographic location is included within any of the geographic areas corresponding to the defined markets. If the associated geographic location is included in a geographic area corresponding to a defined market, the content selection module 210 identifies and returns a market-specific landing page 212 or overlay message 214 associated with the defined market to the end user client device 107. If the associated geographic location is not included in a geographic area corresponding to a defined market, the content selection module 210 identifies and returns a default or generic landing page (not shown) or overlay message (not shown) to the end user client device 107.

Alternately or additionally, if the associated geographic location is included in a geographic area corresponding to a defined market and the end user client device 107 is identified as a mobile end user client device, the content selection module 210 identifies and returns a market-specific landing page 212 or overlay message 214 that has been customized for mobile end user client devices. Alternately or additionally, if the end user client device 107 is identified as a mobile end user client device, the content selection module 210 identifies and returns a mobile-device-specific landing page 212 or overlay message 214.

In some embodiments, the conversion application 116 allows an administrator to track conversion rates and make changes to landing pages 212 and/or overlay messages 214 on a market-by-market basis to improve conversion rates. For instance, if the statistics generated by counter component 204 indicate that a first market has a conversion rate that is lower than a predetermined threshold and/or that is relatively lower than the conversion rate of a second market, an administrator can operate the design component 118 to quickly modify the landing page or overlay message corresponding to the first market to drive up conversions. For instance, the administrator may modify the landing page or overlay message to include a discount (or a relatively deeper discount) on purchases for end users within the first market to drive up electronic transactions through the web site 110A in the first market.

### III. Design Component

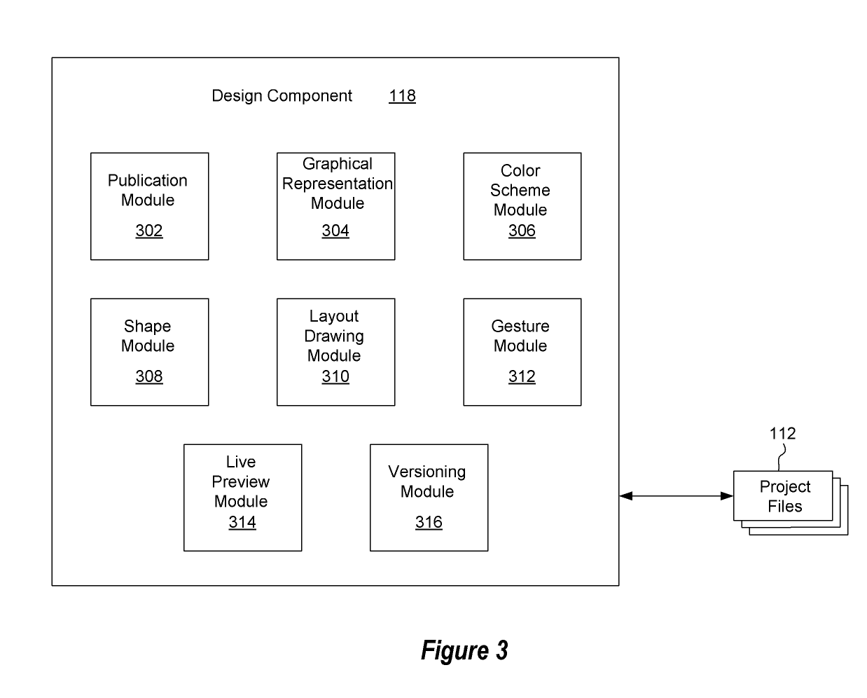

With additional reference to FIG. 3, an example configuration of the design component 118 is disclosed. As illustrated in FIG. 3, the design component 118 includes publication module 302, graphical representation module 304, color scheme module 306, shape module 308, layout drawing module 310, gesture module 312, live preview module 314 and versioning module 316.

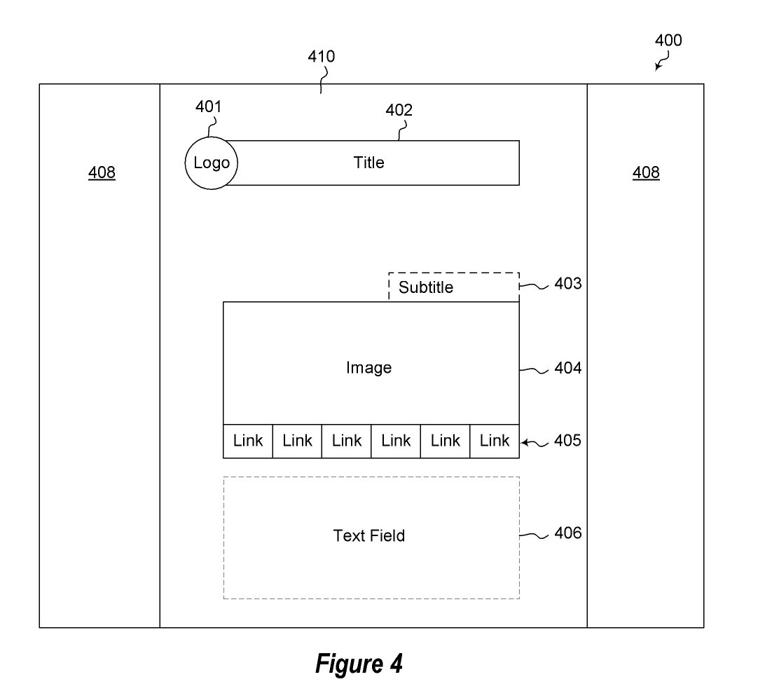

Prior to describing the design component 118 in further detail, an example layout 400 for a web site is disclosed with respect to FIG. 4. Each layout 400 is defined by a corresponding project file 112 and can be displayed on a display device included with, e.g., administrator client device 106. The term “layout” refers to a structured arrangement of elements for a web site that applies across every web page within a group of web pages in the web site. The layout may apply to every element in the web site or to a subset of the elements in the web site. As will become evident from the description that follows, the use of layouts in designing web sites provides a simple method of achieving a consistent look and feel across all web pages within a web site.

As shown in FIG. 4, the layout 400 includes a plurality of elements 401-406, including a logo element 401, a title element 402, a subtitle element 403, an image element 404, a plurality of link elements 405 and a text field element 406. The elements 401-406 are merely discussed by way of example and layouts 400 may more generally include any number of elements that are the same as and/or different than the elements 401-406. For instance, elements 401-406 can include text fields, images including bit-mapped and vector graphics images, animations, video, audio, plugins such as flash, quicktime and java run-time plugins, or the like.

The project file 112 defining the layout 400 in some embodiments uses an extensible markup language (“XML”)-based syntax to define the layout 400. Alternately or additionally, the project file 112 defining the layout 400 includes an object representation of each of the elements 401-406. Accordingly, each object representation in project file 112 may define one or more of a positioning property, size property, outline property, shape property, color property, depth property, and/or other properties of the corresponding element 401-406.

The positioning property refers to the position of the corresponding element 401-406 when displayed on a display device and may be defined in some embodiments by an x, y coordinate pair. The size property refers to the dimensions of the element 401-406. The outline property refers to whether an outline is displayed around the element. For instance, outlines are displayed around elements 401, 402, 404 and 405, but not around elements 403 and 406 (the dotted lines around elements 403 and 406 indicates the absence of an outline). The shape property refers to a shape of the outline around the element 401-406. The color property refers to the color of content (e.g., text) within the element 401-406, the color of the outline of the element 401-406 and/or the color of the space between the outline and the element 401-406. The depth property refers to the relative positioning of an element 401-406 in front of or behind another element 401-406.

As previously explained, the term “layout” refers to a structured arrangement of elements for a web site that applies across every web page within a group of web pages in the web site. Thus, in the example of FIG. 4, each of elements 401-405 is configured to generally appear identically with the same attributes in every web page of a group of web pages within a corresponding web site 110. However, the text field element 406 is configured to vary from page to page. In particular, the text field element 406 may include one set of text in one of the web pages, another set of text in another of the web pages, and so on.

Accordingly, in some embodiments, a unique element ID is assigned to each element 401-406. Each element 401-406 additionally has a Boolean flag that specifies whether changes in content, styling or position of the element 401-406 will take effect in all other web pages in the layout's 400 current group of web pages.

Thus, in some embodiments, when a web page within the layout 400 is being edited, the design component 118 checks the web page to determine if it is a control page. If the web page is a control page, its control ID is checked against all other pages in the layout 400. Matching control IDs denote the group of web pages. Every element on the web page being checked is compared to every element on the control page for matching element IDs.

When an element ID on a control page matches the element ID on a page being checked it is assumed by design component 118 that these elements are intended to be the same. Because the element ID is assigned only when the element is created, two elements on different pages can only have the same element ID if they were created as one object and then duplicated from one page to another. If the elements have matching element IDs and the element on the control page is set to apply to all pages, all the properties from the element on the control page are copied to the corresponding element on the page being checked.

If an element on the control page is set to apply to all pages, and an element with a matching element ID is not found on the page being checked, then an exact duplicate of the element from the control page is created on the page being checked. After this process is completed, all elements are reassigned depth positions to ensure that the ordering of the layout has not been compromised.

The embodiments described herein include web sites based on a single layout, as well as web sites based on two or more layouts. In the case of a web site based on two or more layouts, the web site may include a first group of web pages tied to a first layout, a second group of web pages tied to a second layout, and so on. As such, some embodiments of the design component 118 permit an administrator to group web pages together, to undo groupings, and/or to create new groups of web pages.

FIG. 4 also illustrates background space 408 and foreground space 410. In particular, background space 408 includes all of the area outside of the layout 400 that automatically expands or contracts depending on the display settings of a browser 120, 124 on end user client device 107 or customer client device 108. Foreground space 410 includes all of the area inside the layout 400 upon which the elements 401-406 are arranged. Optionally, the project file 112 defines one or more properties for each of the background space 408 and foreground space 410, such as a color property and/or other properties.

In some embodiments, the design component 118 has access to a plurality of predefined layouts in the form of read-only project files 112. In this example, when designing a new web site, an administrator can select one of the predefined layouts by opening a corresponding read-only project file 112. After opening the read-only project file 112, the administrator can then customize the elements 401-406 as desired and save the changes as a new project file 112.

A. Publication Module

Returning to FIG. 3, the publication module 302 of design component 118 is configured to publish the project file 112 to a web site 110 for hosting by host server 104. Publishing the project file 112 to a web site 110 includes, in some embodiments, translating the XML-based format of the project file 112 to HTML or other suitable format.

In some embodiments, and in more detail, prior to publishing the project file 112 to a web site 110, the publication module 302 analyzes the project file 112 as a whole. All pages within the project file 112 are assigned filenames. The publication module 302 also compares each page within the project file 112 to ensure that they are all correctly rendered in regards to their layout groupings.

After analyzing the project file 112 as a whole, the publication module 302 loads each page one by one and begins the process of rendering the graphical outputs. The publication module 302 hides non graphical elements such as text so that the non graphical elements are not rendered into the graphical output. Each page may be rendered as followed:

1. The process of rendering performed by the publication module 302 is akin to taking a screenshot. All images are rendered as either JPEG or PNG format as determined by the format of the source graphic in some embodiments. First the background is rendered to JPEG. Then the foreground is rendered to JPEG. Any graphical element such as an image is not rendered with the foreground graphic. The background and foreground elements are rendered in a way that ensures they are able to be tiled. Regardless of the position in the graphical representation of the layout, the published background always places the bitmapped graphic at the position (0,0) and renders in the same dimensions as the source bitmap graphic. The foreground graphic renders in the cumulative dimensions of the layout content.

2. Following rendition of the background and foreground, all graphical elements, such as images and buttons, are rendered. These graphical elements are rendered in the same manner as the background and foreground except that they match the dimensions of the source object exactly in some embodiments.

3. After all graphical elements have been rendered (e.g., as JPEG or PNG in the present example), the publication module 302 examines and converts to HTML the content of each element on the page in the order of their depth. The element with the lowest depth is handled first according to some embodiments.

4. Each element has a corresponding DIV tag in the published HTML page.

5. The DIV tag contains pointers to CSS classes that contain dimensions and positioning.

6. Each DIV tag is relatively positioned. This means that the positioning of the previously published elements will affect the DIV positioning of the currently published element. Generally only positioning on the Y-axis is affected. As such, the absolute positioning is converted to the relative value of their DIV counterpart in some examples. The relative y-position is the negative sum total of all previous DIV heights and the current DIV's absolute Y-position.

7. Graphical elements are given IMG tags that contain source references to the images that were previously rendered.

8. The text elements extend Adobe's TextField class in some examples. As such, the text content contained within is sanitized and converted to XHTML compliant HTML code.

9. Optionally, the design component 118 and/or conversion application 116 implements a Custom element that serves as a container for varying widgets and code as is described herein. The Custom element pulls all variables and source code from corresponding external XML sources. During publishing by the publication module 302, all Custom elements retrieve their source code from corresponding external sources and insert it into the corresponding DIV tag. Any variables that may be set by the user are inserted into the source code via a markup. Any external files that are required by the Custom elements are also downloaded and added to an upload queue at this time.

10. Each element is also checked for visibility. Every element in a layout can belong to a visibility group. The elements in these groups are shown or hidden by their visibility group identifier. All visibility groups start out hidden and can be shown or hidden when a visitor to the web site triggers an event as specified by the designer of the web site. These events can be clicking on or rolling over a button or linked text. This gives the designer the ability to easily create dynamic content such as rollover buttons or drop down menus. When an element is determined to be a member of a visibility group it has additional class declarations added. A JavaScript library that is included with the published files handles the visibility events.

11. After all elements have been processed they are then compiled into an HTML file and a CSS style sheet. The HTML file contains the declarations and ordering of each element while the CSS style sheet contains all the positioning, coloring, and styling for the document and each element contained within. The compiled HTML and CSS are added to the upload queue.

The publication module 302 then repeats processes 1-10 until all pages have been rendered graphically and all HTML code has been generated. Further, the compiled HTML and CSS uploaded to the queue are uploaded to a host server such as host server 104 using standard File Transfer Protocol (“FTP”) or other suitable protocol commands directly through the design component 118 and/or conversion application 116.

B. Graphical Representation Module

With combined reference to FIGS. 3-4, the graphical representation module 304 is configured to generate the graphical representation of the elements 401-406. In some embodiments, the graphical representation module 304 is a plurality of modules that are extended from various Adobe classes such as the bitmap class.

C. Color Scheme Module

The color scheme module 306 globally controls colors across web pages within a layout 400. In some embodiments, the color scheme module 306 emulates a CSS style sheet. For instance, the color scheme module permits the color property of one or more of the elements 401-406, background space 408 and/or foreground space 410 to be tied to a particular color component of a color scheme.

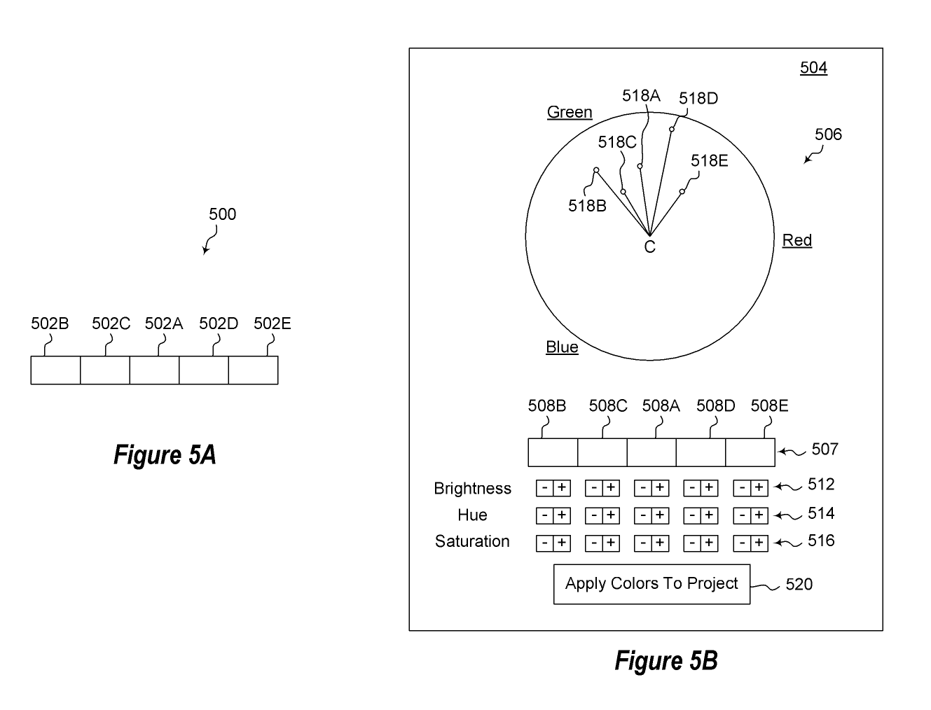

In more detail, FIG. 5A depicts a first representation of a color scheme 500 including a primary color component 502A and one or more secondary color components 502B-502E (collectively “color components 502”). In some embodiments, the design component 118 has access to a plurality of predefined color schemes 500 stored on host server 104 or other suitable location that are selectable by an administrator. Optionally, after the administrator has selected a color scheme 500, the color scheme module 306 automatically associates one or more of the color components 502 with one or more of the elements 401-406, background space 408 and/or foreground space 410 and applies the color components 502 to the elements 401-406, background space 408 and/or foreground space 410 accordingly. Alternately or additionally, the color scheme module 306 permits the administrator to manually associate a particular one of the color components 502 with a particular one of the elements 401-406, background space 408 and/or foreground space 410 on an individual basis.

In this example, if the administrator desires to alter the color of all of the elements 401-406, background space 408 and foreground space 410 that are associated with a particular one of color components 502, the color scheme module 306 allows the administrator to simply change the color of the particular color component 502 and then globally applies the change to alter the color of every element 401, background space 408 and foreground space 410 that are associated with the particular color component 502, rather than requiring the administrator to individually alter the color of each affected element 401-406, background space 408 and foreground space 410.

In some embodiments, the predefined color schemes 500 include color components 502 that are selected, e.g., by a creator of the color scheme 500, to look aesthetically pleasing together. Optionally, the color scheme module 306 provides functionality for automatically altering the secondary color components 502B-502E to maintain an aesthetically pleasing combination when the administrator alters the primary color component 502A.

In this and other examples, and with additional reference to FIG. 5B, the color scheme module 306 provides an interface 504 that includes a color wheel 506 derived from the hue, saturation, brightness (“HSB”) color space. Because FIG. 5B is presented as a black and white line drawing, regions generally corresponding to the red, green and blue color hues are labeled as such around the perimeter of the color wheel 506. In the color wheel 506, the angle around a center C of the color wheel 506 corresponds to hue while the radius from the center C corresponds to color saturation with maximum color saturation at the perimeter of the color wheel 506.

The interface 504 further includes a color scheme 507 having a primary color component 508A and a plurality of secondary color components 508B-508E (collectively “color components 508”). Each of the color components 508 is characterized by brightness, hue and saturation, which characteristics are adjustable in the example of FIG. 5B by clicking on an appropriate one of the brightness, hue or saturation buttons 510, 512, 514 beneath the corresponding color component 508.

As depicted in FIG. 5B, the color wheel 506 graphically represents the color scheme 507 using color points 518A-518E (collectively “color points 518”) respectively corresponding to color components 508A-508E. In this and other examples, the polar coordinates of the color points 518 in the color wheel 506, including the angle and radius of each color point 518, correspond to the hue and saturation of each color component 508. Accordingly, the hue and saturation characteristics of each of color components 508 can be described in terms of angle and radius of each of the corresponding color points 518 in the HSB color space-derived color wheel 506. Further, at least the hue and saturation of color components 508 are adjustable in the present example by clicking and dragging a corresponding color point 518 to a different angle and/or radius within the color wheel 506.

In some embodiments, the color components 508 are selected to look aesthetically pleasing together. To allow an administrator to adjust the characteristics of the color components 508 while maintaining the color components 508 in an aesthetically pleasing combination, the color scheme module 306 is configured in this and other examples to automatically adjust the characteristics of the secondary color components 508B-508D anytime the characteristics of the primary color component 508A are adjusted.

For example, each of secondary color components 508B-508E is angularly offset from the primary color component 508A by a predetermined amount in the HSB color space. As such, anytime the administrator changes the angle of the primary color component 508A in the HSB color space, the color scheme module 306 automatically adjusts the angle of each of the secondary color components 508B-508E within the HSB color space to maintain the predetermined angular offsets in some embodiments.

Further, each of secondary components 508B-508E is radially offset from the primary color component 508A by a predetermined amount in the HSB color space. As such, anytime the administrator changes the radius of the primary color component 508A in the HSB color space, the color scheme module 306 automatically adjusts the radius of each of the secondary color components 508B-508E within the HSB color space to maintain the predetermined radial offsets in some embodiments. In this and other examples, the radial adjustments of secondary color components 508B-508E are permitted up to the maximum radius defined by the perimeter of the color wheel 506.

Alternately or additionally, the automatic adjustments to the radius of each of secondary color components 508B-508E in response to a change in the radius of primary color component 508A can be based on other parameters. For instance, the automatic adjustment to the radius of each of the secondary color components 508B-508E can be based on maintaining predetermined ratios between the radius of the primary color component 508A and the radius of each of the secondary color components 508B-508E.

The interface 504 thus permits an administrator to change the hue, saturation or brightness of any of color components 508 using buttons 512, 514, 516 and/or the color wheel 506. Optionally, the interface 504 further includes a button 520 for applying the changes to the web pages within the layout 400. In this example, after the administrator has made any manual changes, the color scheme module 306 has made any automatic changes, and the administrator has clicked on the button 520, the color scheme module 306 applies the modified color scheme 507 to the layout 400, including updating the color of all elements 401-406, background space 408 and/or foreground space 408 that are tied to the various color components 508 of the color scheme 507.

D. Shape Module

Returning to FIGS. 3-4, the shape module 304 controls the shape of an outline of elements 401-406. The shape module 304 may be configured to interpret one or more vector graphics formats. In some embodiments, shape module 304 allows an administrator to apply one or more different outline shapes to the elements 401-406.

E. Layout Drawing Module

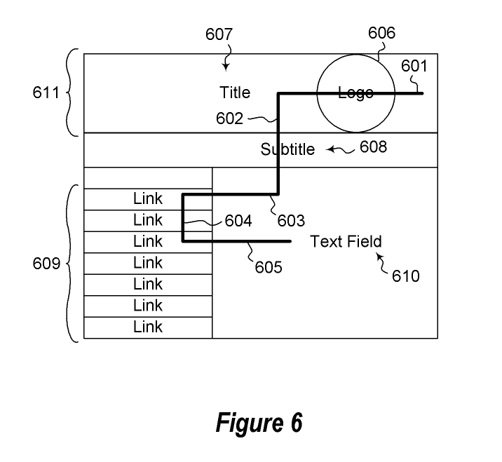

The layout drawing module 310 is configured to generate a layout based on a series of gesture-based inputs from an administrator through administrator client device 106. For instance, FIG. 6 illustrates one example of a layout 600 generated by the layout drawing module 310 based on a series of gesture-based inputs from an administrator.

In the example of FIG. 6, the administrator selects a layout drawing option and performs a gesture using an input device such as a mouse or touch-sensitive screen of the administrator client device 106. User input representing the gesture is received by the design component 118. As will be described in greater detail below, the gesture module 312 analyzes the user input to identify the gesture. In the example of FIG. 6, the gesture includes the administrator drawing a plurality of sequentially connected line segments 601, 602, 603, 604, 605 on the display of the administrator client device 106.

The layout drawing module 310 then implements an action associated with the identified gesture. In the present embodiment, the action includes creating the layout 600 having a plurality of elements 606-610, including logo element 606, title element 607, subtitle element 608, a plurality of link elements 609 and a text field element 610. Each of the elements 606-610 is created in association with a corresponding one of the sequentially connected line segments 601-605. In particular, the logo element 606 is created in associated with the line segment 601, the title element 602 is created in association with the line segment 602, the subtitle element 608 is created in association with the line segment 603, the link elements 609 are created in association with the line segment 604, and the text field element 610 is created in association with the line segment 605.

In some embodiments, the elements 606-610 appear on a display of administrator client device 106 in sequential order as the corresponding line segments 601-605 are drawn on the display by the administrator using the input device.

Alternately or additionally, the layout drawing module 310 is configured to deposit each element 606-610 in the most logical location of the layout 600. For instance, the layout drawing module 310 may be configured to always deposit the title element 607 to appear horizontally and/or to always deposit the subtitle element 608 to always appear immediately below the title element 607.

In some embodiments, the layout drawing module 310 is configured to add a main banner 611 including the logo element 606 in the same orientation as the initial line segment 601. In particular, whereas the initial line segment 601 is horizontal in FIG. 6, the main banner 611 is added horizontally across the top of layout 600. Optionally, after the administrator has drawn the initial line segment 601 and the layout drawing module 310 has caused the logo element 606 and main banner 611 to appear, the layout drawing module 310 highlights the remaining available area for adding new elements. As new elements are added, the highlighted area shrinks. Every time a change of direction occurs in the sequentially drawn line segments 601-605, e.g., every time one line segment 601-605 ends and a new line segment 601-605 begins, the layout drawing module 310 adds a new element if the change of direction occurs in the highlighted area.

After the layout 600 is created using the layout drawing module 306, the administrator can select an editing or other option to eliminate the sequentially connected line segments 601-605 and/or edit the elements 606-610 as desired.

F. Gesture Module

The gesture module 312 is configured to analyze gesture-based user input to identify gestures performed by an administrator using an input device of administrator client device 106 and to implement appropriate actions. In some embodiments, the actions that can be implemented include creating a layout in association with layout drawing module 310, creating a new element, selecting a pre-existing element and deleting a pre-existing element. Alternately or additionally, the gesture module 312 may implement more or fewer actions that are the same or different than the actions of creating, selecting and deleting elements.

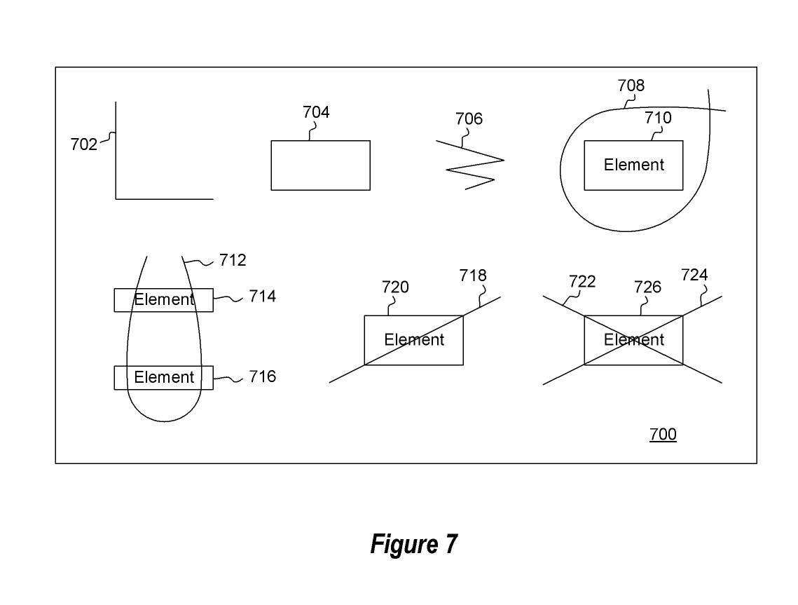

With additional reference to FIG. 7, a plurality of gestures that may be performed by an administrator using administrator client device 106 to implement certain actions are discussed according to some embodiments. FIG. 7 is a screen shot of a display 700 associated with the administrator client device 106.

One gesture having an associated action is drawing an “L” shape 702 on the display 700 using an input device such as a mouse (not shown) or a touch-sensitive display 700. An “L” shape includes any combination of one substantially horizontal line segment and one substantially vertical line segment joined at a common vertex, without regard to the respective lengths of the two line segments. In operation, user input representing the gesture of drawing an “L” shape 702 is received by the gesture module 312. The gesture module 312 analyzes the user input to identify the corresponding gesture and then implements an action associated with the identified gesture of drawing the “L” shape 702. In some embodiments, the action associated with drawing an “L” shape 702 is to create an image element (not shown) in place of the “L” shape 702. The created image element is a placeholder in some examples that permits the administrator to insert an image in the area of the placeholder.

Another gesture having an associated action is drawing a rectangle shape 704 on the display 700 using an input device. The term “rectangle” includes any quadrilateral having four right angles and thus extends to square shapes. The action associated with drawing a rectangle shape 704 is the same action associated with drawing an “L” shape 702, namely, creating an image element (not shown) in place of the rectangle shape 704.

According to some embodiments, the image element created in place of an “L” shape 702 or rectangle shape 704 is rectangle shaped and is proportional to the dimensions of the “L” shape 702 or rectangle shape 704. Alternately, the image element created in place of an “L” shape 702 or rectangle shape 704 is a predetermined shape and/or size that is not proportional to the dimensions of the “L” shape 702 or rectangle shape 704.

With continued reference to FIG. 7, another gesture having an associated action is drawing a zigzag line 706 on the display 700 using an input device. The action associated with drawing a zigzag line 706 is creation of a text field element (not shown). In some embodiments, the size of the text field element is proportional to the width and height of the zigzag line 706. In other embodiments, the size of the text field element is predetermined and is not proportional to the width and height of the zigzag line 706.

Another gesture having an associated action is drawing a lasso 708 around one or more elements 710 on the display 700 using an input device. The action associated with drawing a lasso 708 around one or more elements 710 is to select all of the one or more elements 710. Optionally, the gesture module 312 or other module of design component 118 highlights each of the selected one or more elements 710 to indicate that they have been selected. After selection, the one or more elements 710 can then be moved around the display 700 while their positioning relative to each other remains unchanged.

Another gesture having an associated action is drawing a lasso 712 through one or more elements 714, 716 such that the lasso 712 crosses each of the one or more elements 714, 716 twice on the display 700 using an input device. The action associated with drawing a lasso 712 through one or more elements 714, 716 twice is to select all of the one or more elements as already described above with respect to the lasso 708.

Another gesture having an associated action is drawing a diagonal line 718 across an element 720 on the display 700 using an input device. The action associated with drawing a diagonal line 718 across an element 720 is to delete the element 720.

Another gesture having an associated action is drawing two diagonal lines 722, 724 in an “X” shape across an element 726 on the display 700 using an input device. The action associated with drawing two diagonal lines 722 in an “X” shape across an element 726 is to delete the element 726.

In the examples provided above with respect to FIG. 7, the gesture module 312 is generally configured to receive user input corresponding to a particular gesture performed by the administrator via an input device of the administrator client device 106. The gesture module 312 is also configured to analyze the user input to identify the gesture.

The gesture may be one or more of drawing an “L” shape 702, drawing a rectangle shape 704, drawing a zigzag line 706, drawing a lasso 708, 712, or drawing one or more diagonal lines 718, 722, 724 using the input device. In these examples, the user input represents one or more line segments of “L” shape 702, rectangle shape 704, zigzag line 706 or diagonal lines 718, 722, 724, and/or curved line segments of lassos 708, 712. Thus, analyzing the user input to identify the gesture may include applying one or more mathematical equations to the user input to determine a direction of each line segment/curved line segment and/or comparing the direction of each line segment/curved line segment to the direction of a previous line segment/curved segment.

In some embodiments, to determine the gesture intended by the corresponding shape 702, 704, 706, 708, 712, 718 or 724, the gesture module 312 uses a system of angle calculations to determine if the vector of the current line segment of the shape 702, 704, 706, 708, 712, 718 or 724 being drawn is horizontal, vertical, diagonal, or some combination thereof.

To this end, in some embodiments, the gesture module 312 stores every point in the line segment of the shape 702, 704, 706, 708, 712, 718 or 724 being drawn in an array containing X and Y coordinate pairs. As the shape 702, 704, 706, 708, 712, 718 or 724 is being drawn by the user, the current line position, e.g., the most recent point pushed to the array, is compared to the preceding point. An angle value, in radians, is determined. The latest point added is compared to the second most recent point to determine the angle between the two points. The gesture module 312 checks this angle value to determine if it is diagonal, horizontal, and then vertical. If it falls between certain radian values which are predetermined thresholds, the segment is considered to be any one of the three aforementioned direction types. Any radian values that fall outside of these thresholds are ignored.

At the start of each gesture by a user, an empty string is created which records every time a new direction type has been identified. Horizontal values are identified in the string by an “H” or other suitable identifier, vertical values are identified by a “V” or other suitable identifier, and diagonal values are identified by a “D” or other suitable identifier. When the user terminates the gesture, e.g., by releasing the mouse, the string of letters is compared to a predetermined set of constant values to determine the necessary course of action. For example, “HV” is a predetermined constant value representing an “L” gesture by a user corresponding to the L shape 702. As another example, “VHVH” may be used as a predetermined constant value representing a rectangle gesture corresponding to the rectangle shape 704. Any concurrent combination of these constant values is also acceptable when determining the intent of a gesture. For instance, “VH” is a concurrent combination of “HV” and “HVHV” is a concurrent combination of “VHVH”. This allows the user to draw a gesture in any direction.

In some embodiments, Left, Right, Up and Down are tracked in addition to Horizontal, Vertical and Diagonal. In particular, Horizontal segments are checked for Left and Right values and Vertical segments are checked for Up and Down values. Left, Right, Up and/or Down are determined by the positioning of the most recently drawn point relative to the previous point. For example, if the most recently drawn point's X-coordinate value is less than the previous point's X-coordinate value than the current Horizontal segment is directed to the Left. For example, a zig-zag gesture such as may correspond to the zig-zag shape 706 is identified by an oscillating series of Left and Right or Up and Down values of a predetermined length. The Up, Down, Left and Right values are stored in an empty string that may be separate from the string containing the Horizontal, Vertical and Diagonal values. Thus, a zig-zag gesture may be represented by at least one string that includes Right-Left-Right values and optionally another string that includes Diagonal values.

In some embodiments, the Horizontal, Vertical, Diagonal string has priority over the Right, Left, Up, Down string when analyzed by the gesture module 312. Alternately or additionally, if more than one gesture is identified in the one or more strings created for the gesture, the gesture module 312 implements the action associated with the first gesture an discards the rest.

G. Live Preview Module

With combined reference to FIGS. 1 and 3, the live preview module 314 is configured to capture screen shots of the display of administrator client device 106 and provide the screen shots to customer client device 108. In some embodiments, the live preview module 314 captures screen shots from administrator client device 106 and pushes data representing the screen shots through the network 102 as a simulated webcam to customer client device 108 substantially in real time. A plugin such as flash or other suitable pluggable for the browser 124 on customer client device 108 then displays the captured screen shots to the customer associated with customer client device 108. The captured screen shots are provided and displayed to the customer substantially in real time; as such, the capture screen shots are referred to as a live preview.

By providing the customer with a live preview of the display of the administrator client device 106, the customer can view in real time as changes are made to the customer's hosted web site 110 by the administrator. More particularly, the changes are actually made to the corresponding project file 112, but because of the configuration of the design component 118 as disclosed herein, any changes to the project file 112 will directly translate to the customer's hosted web site 110 when the project file 112 is published. When the live preview capability is combined with some form of substantially real time textual or verbal communication such as chat, VOIP, telephone, cell phone, or the like, the customer is able to view and suggest/approve changes to the web site 110 in real time, thereby streamlining the process of changing the customer's hosted web site 110.

Rather than being included as part of the design component 118, the live preview module 314 can alternately be provided as separate third party software separate from the design component 118. One example of such third party software is marketed by PCWinSoft Systems Ltd. as ScreenCamera software.

H. Versioning Module

The versioning module 310 is configured to version project files 112. In some embodiments, anytime a project file 112 corresponding to a web site 110 is changed and re-published, the versioning module 310 stores a new version of the project file 112 on the host server 104.

### IV. Example Methods of Operation

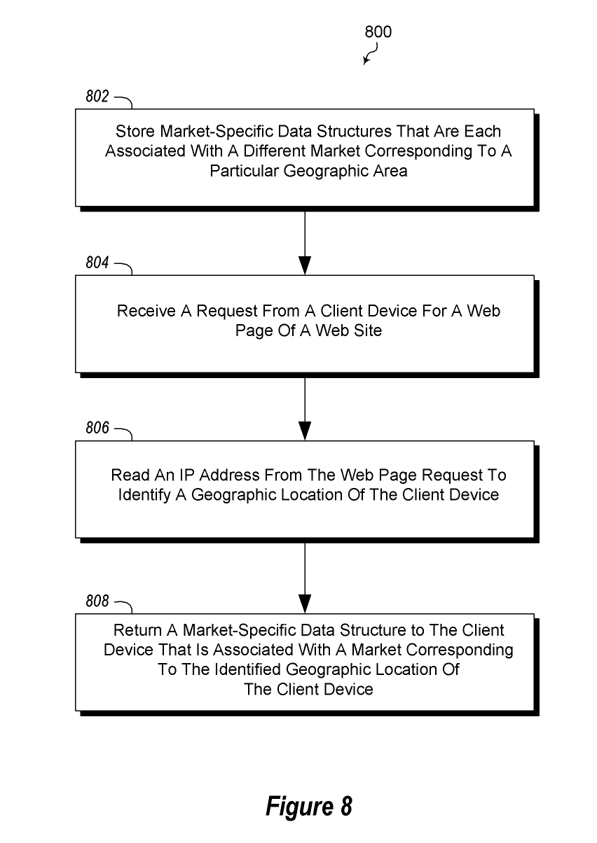

Turning next to FIG. 8, an example method 800 of servicing requests from end user client devices 107 is disclosed. The method 800 may be performed in some embodiments by the host server 104 of FIG. 1, and more particularly by the conversion application 116 running on the host server 104. The method begins at 802 by storing a plurality of market-specific data structures that are each associated with a different market corresponding to a particular geographic area. Each of the market-specific data structures is a market-specific landing page or market-specific overlay message including content customized for the corresponding market.

At 804, the host server 104 receives a request from an end user client device 107 for a web page of a web site 110 hosted by the host server 104. The request is an HTTP GET request in some embodiments.

At 806, the host server 104 reads an IP address from the web page request to identify a geographic location of the end user client device 107.

At 808, the host server 104 returns, to the end user client device 107, a market-specific data structure that is associated with a market corresponding to the identified geographic location of the end user client device 107.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For instance, the method 800 may further include one or more of tracking a navigation path of each of a plurality of end user client devices 107 that navigate the web site 110; determining conversion rates based on navigation path, landing page and/or convey message; or the like or any combination thereof. Alternately or additionally, the method 800 includes identifying the end user client device 107 as a mobile end user client device and, at 808, returning a market-specific data structure to the end user client device 107 that has been customized for mobile devices, or simply a mobile-device-specific data structure that has been customized for mobile devices.

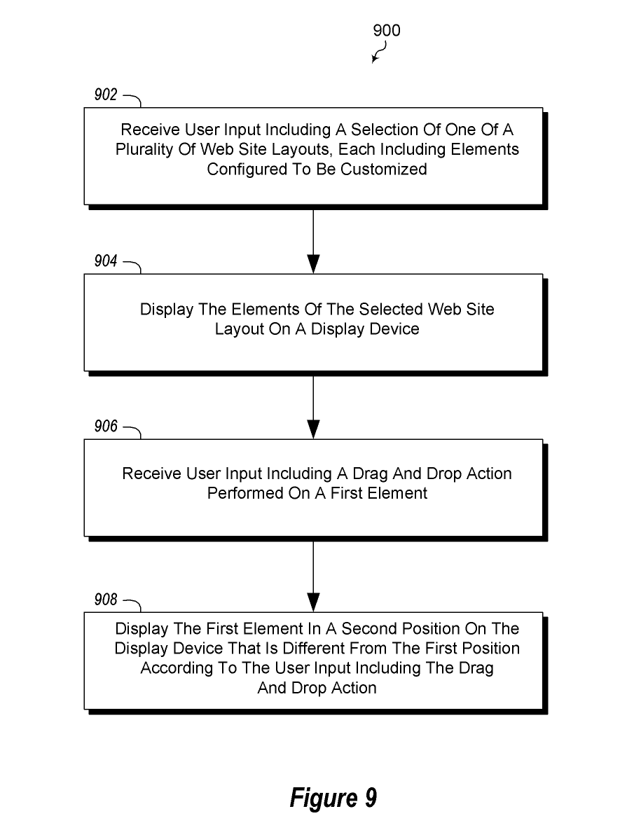

Turning next to FIG. 9, an example method 900 of generating a web site including one or more web pages is disclosed. The method 900 may be performed in some embodiments by the administrator client device 106 of FIG. 1, and more particularly, by the design component 118 executing on administrator client device 106. The method 900 begins at 902 by receiving user input including a selection of one of a plurality of web site layouts, each web site layout including a plurality of elements configured to be customized by a user.

Optionally, prior to receiving the user input at step 902, the method 900 may further include retrieving a plurality of representations corresponding to the web site layouts and displaying the representations to an administrator via a display device of the administrator client device 106.

The method 900 continues at 904 by displaying the plurality of elements of the selected web site layout on the display device. In some examples, the plurality of elements includes at least a first element that is displayed in a first position on the display device.

At 906, the administrator client device 106 receives user input including a drag and drop action performed on the first element. For instance, with reference to FIG. 4, receiving user input including a drag and drop action may include receiving user input selecting one of elements 401-406 using a mouse or other input device, dragging the selected one of elements 401-406 to a new position, and releasing the selected one of elements 401-406 in the new position. Alternately or additionally, with combined reference to FIGS. 3-4, the graphical representation module 304 of design component 118 modifies the positioning property of the selected one of the elements 401-406 to reflect the new position of the selected one of the elements 401-406 in response to receiving the user input including the drag and drop action.

At 908, the administrator client device 106 displays the first element in a second position on the display device that is different from the first position according to the user input including the drag and drop action.

Although not depicted in FIG. 9, the method 900 alternately or additionally includes, for instance, creating a new project file including the selected web site layout; publishing the new project file to a predetermined format (such as HTML) as a new website; hosting the new web site for access by one or more client devices; capturing substantially real time screens shots of the display device and transmitting the screen shots to a client device associated with the customer; receiving user input adding a new page to the selected web site layout; receiving user input separating the new page from the selected web site layout; receiving gesture-based user input and implementing one or more actions associated with the gesture-based user input; receiving user input adjusting a characteristic of a primary color component in a color scheme; automatically adjusting characteristics of one or more secondary color components in the color scheme to maintain a predetermined relationship with the primary color component, or the like or any combination thereof. Furthermore, the method 900 of FIG. 9 may be performed separately from the method 800 of FIG. 8 or combined in any way with the method 800 of FIG. 8.

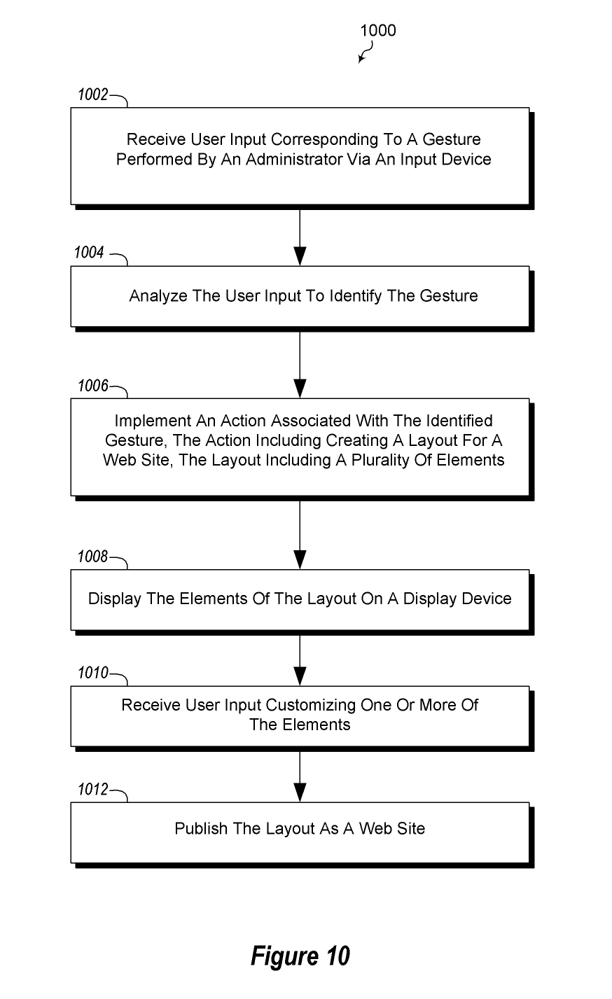

Turning next to FIG. 10, an example method 1000 of generating a web site including one or more web pages is disclosed. The method 1000 may be performed in some embodiments by the administrator client device 106 of FIG. 1, and more particularly, by the design component 118 executing on administrator client device 106. The method 1000 begins at 1002 by receiving user input corresponding to a gesture performed by an administrator via an input device such as a mouse or touch-sensitive display of administrator client device 106.

At 1004, the administrator client device 106 analyzes the user input to identify the gesture. The step 1004 of analyzing the user input to identify the gesture may include applying one or more mathematical equations to the user input to determine directions of one or more line segments that are represented by the user input and that were drawn on a display device of the administrator client device 106. In the example of FIG. 10, the identified gesture includes the administrator drawing a plurality of sequentially connected line segments on the display device using the input device.

At 1006, the administrator client device 106 implements an action associated with the identified gesture. In the example of FIG. 10, the action includes creating a layout for a web site having a plurality of web pages such as in the manner described above with respect to FIG. 6. The layout includes a plurality of elements, wherein at least one of the elements is uniformly included across each of the web pages.

At 1008, the administrator client device 106 displays the elements of the layout on the display device of the administrator client device 106.

At 1010, the administrator client device 106 receives user input customizing one or more of the elements of the layout. User input customizing an element may include user input resizing the element, user input including a drag and drop action to re-position the element; user input changing a color, outline, or other property of the element, or the like or any combination thereof.

At 1012, the administrator client device 106 publishes the layout as a web site. In some embodiments, publishing 1012 the layout as a web site includes publishing a project file 112 including the layout as one or more HTML pages, or the like or any combination thereof.

Although not depicted in FIG. 10, the method 1000 alternately or additionally includes, for example, receiving user input corresponding to a second gesture performed by the administrator via the input device; analyzing the user input corresponding to the second gesture to identify the second gesture; implementing a second action associated with the second gesture, the second action including one or more of: creating a new element, selecting a pre-existing element, or deleting a pre-existing element; or the like. In these and other examples, the second gesture may include one or more of drawing an “L” shape, a rectangle shape, a zigzag line, a lasso, or one or more diagonal lines using an input device. Moreover, the method 1000 of FIG. 10 may be performed separately from the methods 800 and 900 of FIGS. 8-9 or combined in any way with the methods 800 and 900 of FIGS. 8-9.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of generating a web site including one or more web pages, the method comprising:
receiving user input including a selection of one of a plurality of web site layouts, each web site layout including a plurality of elements configured to be customized by a user;
displaying the plurality of elements of the selected web site layout on a display device, including displaying a first element in a first position on the display device;
receiving user input including a drag and drop action performed on the first element; and
displaying the first element in a second position on the display device that is different from the first position according to the user input including the drag and drop action.

2. The method of claim 1, wherein the user is a first user and the display device is a first display device, the method further comprising, while receiving user input customizing one or more elements of the selected web site layout from the first user:
capturing substantially real-time screens shots of the first display device;
transmitting the screen shots to a client device associated with a second user for display to the second user, the client device including a second display device, the client device being remotely located from the first display device.

3. The method of claim 1, further comprising:
creating a new project file for a new web site, the new project file including the selected web site layout;
after receiving user input customizing one or more of the plurality of elements of the selected web site layout, publishing the new project file to a predetermined format as the new web site; and
hosting the new web site for access by one or more client devices over a communication network.

4. The method of claim 3, wherein publishing the new project file to a predetermined format includes translating the new project file from an extensible markup language (“XML”)-based format to a hypertext markup language (“HTML”) format.

5. The method of claim 3, wherein the new project file includes an object representation of each of the plurality of elements of the selected web site layout, the object representation of each of the plurality of elements including positioning information for the corresponding element, the method further comprising, updating positioning information in the object representation of the first element in response to receiving the user input including the drag and drop action performed on the first element.

6. The method of claim 1, wherein the selected web site layout includes a plurality of pages grouped together, each of the plurality of pages including at least some of the same elements including the first element such that changes made to the first element in a first one of the pages are reflected across all of the pages.

7. The method of claim 6, further comprising:
receiving user input adding a page; and
receiving user input grouping the added page with the pages included in the selected web site layout; or
receiving user input to maintain the added page independent from the group of pages included in the selected web site layout such that the added page includes a different web site layout than the selected web site layout.

8. The method of claim 1, further comprising:
receiving user input corresponding to a gesture performed by the user via an input device;
analyzing the user input to identify the gesture; and
implementing an action associated with the identified gesture including one or more of: creating a new element; selecting a pre-existing element; or deleting a pre-existing element.

9. The method of claim 8, wherein the gesture includes at least one of:
drawing an “L” shape on the display device using the input device;
drawing a rectangle shape on the display device using the input device;
drawing a zigzag line on the display device using the input device;
drawing a lasso around at least one element displayed on the display device using the input device;
drawing a lasso through at least one element using the input device such that the lasso crosses the at least one element two times;
drawing a diagonal line across at least one element displayed on the display device using the input device; or
drawing two diagonal lines in an “X” shape across at least one element displayed on the display device using the input device.

10. The method of claim 1, further comprising receiving user input selecting a color scheme to apply to the selected web site layout, the color scheme including a plurality of colors including a primary color and at least one secondary color angularly offset from the primary color by a predetermined amount in the hue, saturation, brightness (“HSB”) color space.

11. The method of claim 10, wherein a hue of each of the primary and secondary colors depends on an angle of each of the primary and secondary colors in the HSB color space, the method further comprising:
receiving user input adjusting the angle of the primary color in the HSB color space;
automatically adjusting the angle of the secondary color in the HSB color space to maintain the predetermined angular offset with respect to the primary color; and
applying the changes to the hue of the primary and secondary colors to the selected web site layout.

12. The method of claim 10, wherein a ratio of a primary color radius in the HSB color space to a secondary color radius in the HSB color space is a predetermined ratio value and wherein a saturation of each of the primary and secondary colors depends on each of the primary and secondary color radii in the HSB color space, the method further comprising:
receiving user input adjusting the primary color radius;
automatically adjusting the secondary color radius to maintain the predetermined ratio value as long as the secondary color radius does not exceed a maximum radius; and
applying the changes to the saturation of the primary and secondary colors to the selected web site layout.

13. A method of generating a web site including one or more web pages, the method comprising:
receiving user input corresponding to a gesture performed by a user via an input device;
analyzing the user input to identify the gesture;
implementing an action associated with the identified gesture, the action including creating a layout for a web site having a plurality of web pages, the layout including a plurality of elements, wherein at least one of the plurality of elements is uniformly included across each of the plurality of web pages;
displaying the plurality of elements of the layout on a display device;
receiving user input customizing one or more of the plurality of elements of the layout; and
publishing the layout as a web site.

14. The method of claim 13, wherein the identified gesture includes drawing a plurality of sequentially connected line segments on the display device using the input device.

15. The method of claim 14, wherein each of the plurality of elements is created in association with a corresponding one of the sequentially connected line segments.

16. The method of claim 15, wherein the plurality of elements appear on the display device in sequential order as the corresponding sequentially connected line segments are drawn on the display device.

17. The method of claim 13, wherein the gesture is a first gesture and the action is a first action, the method further comprising:
receiving user input corresponding to a second gesture performed by the user via the input device;
analyzing the user input corresponding to the second gesture to identify the second gesture; and
implementing a second action associated with the identified second gesture, the second action including one or more of:
creating a new element;
selecting a pre-existing element; or
deleting a pre-existing element.

18. The method of claim 17, wherein the user input corresponding to the first and second gestures represents one or more line segments drawn on the display device by the user via the input device.

19. The method of claim 18, wherein analyzing the user input corresponding to the first or second gestures to identify the first or second gestures includes applying one or more mathematical equations to the user input corresponding to the first or second gestures to determine directions of the one or more line segments.

20. The method of claim 17, wherein the second gesture includes at least one of:
drawing an “L” shape on the display device using the input device;
drawing a rectangle on the display device using the input device;
drawing a zigzag line on the display device using the input device;
drawing a lasso around at least one element displayed on the display device using the input device;
drawing a lasso through at least one element using the input device such that the lasso crosses the at least one element two times;
drawing a diagonal line across at least one element displayed on the display device using the input device; or
drawing two diagonal lines in an “X” shape across at least one element displayed on the display device using the input device.
